(19) United States
(12) Patent Application Publication
(10) Pub. No.: US 2024/0414740 A1
(43) Pub. Date: Dec. 12, 2024

(54) TECHNIQUES FOR RETRANSMITTING FEEDBACK IN SIDELINK WIRELESS COMMUNICATIONS

(71) Applicant: QUALCOMM Incorporated, San Diego, CA (US)

(72) Inventors: Chih-Hao LIU, San Diego, CA (US); Jing SUN, San Diego, CA (US); Yisheng XUE, San Diego, CA (US); Shaozhen GUO, Beijing (CN); Xiaoxia ZHANG, San Diego, CA (US)

(21) Appl. No.: 18/715,575

(22) PCT Filed: Feb. 18, 2022
(86) PCT No.: PCT/CN2022/076730

§ 371 Date: May 31, 2024

(51) Int. Cl. H04W 72/25; H04L 1/06

(52) U.S. Cl. CPC H04W 72/25; H04L 1/0687

(57) ABSTRACT

Some aspects described herein relate to receiving, from a sidelink transmitting user equipment (UE), one or more first transmissions over a first set of sidelink resources, receiving, from the sidelink transmitting UE, one or more second transmissions over a second set of sidelink resources, and transmitting, to the sidelink transmitting UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback. Other aspects relate to receiving the second feedback with the retransmission of at least the portion of first feedback.

### BACKGROUND

Aspects of the present disclosure relate generally to wireless communication systems, and more particularly, to mechanisms for communicating feedback.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable low-latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in 5G communications technology and beyond may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, a memory configured to store instructions, and one or more processors communicatively coupled with the memory and the transceiver. The one or more processors are configured to execute the instructions to cause the apparatus to receive, from a sidelink transmitting user equipment (UE), one or more first transmissions over a first set of sidelink resources, receive, from the sidelink transmitting UE, one or more second transmissions over a second set of sidelink resources, and transmit, to the sidelink transmitting UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback.

In another aspect, an apparatus for wireless communication is provided that includes a transceiver, a memory configured to store instructions, and one or more processors communicatively coupled with the transceiver and the memory. The one or more processors are configured to transmit, to a sidelink receiving UE, one or more first transmissions over a first set of sidelink resources, transmit, to the sidelink receiving UE, one or more second transmissions over a second set of sidelink resources, and receive, from the sidelink receiving UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback.

In another aspect, a method for wireless communication at a sidelink receiving UE is provided that includes receiving, from a sidelink transmitting UE, one or more first transmissions over a first set of sidelink resources, receiving, from the sidelink transmitting UE, one or more second transmissions over a second set of sidelink resources, and transmitting, to the sidelink transmitting UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback.

In another aspect, a method for wireless communication at a sidelink transmitting UE is provided that includes transmitting, to a sidelink receiving UE, one or more first transmissions over a first set of sidelink resources, transmitting, to the sidelink receiving UE, one or more second transmissions over a second set of sidelink resources, and receiving, from the sidelink receiving UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a flow chart illustrating an example of a method for receiving feedback for SL communications, in accordance with various aspects of the present disclosure;

FIG. 5 is a flow chart illustrating an example of a method for transmitting feedback for SL communications, in accordance with various aspects of the present disclosure;

FIG. 6 illustrates examples of timelines for transmitting feedback for groups of SL transmissions, in accordance with various aspects of the present disclosure;

FIG. 7 illustrates examples of timelines for transmitting feedback based on retransmission indicators, in accordance with various aspects of the present disclosure;

FIG. 8 illustrates an example of a call flow of communications between a sidelink (SL) transmitting (Tx) UE, a SL receiving (Rx) UE, in accordance with various aspects of the present disclosure; and

FIG. 9 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to communicating feedback for sidelink communications. For example, in some wireless communication technologies, such as fifth generation (5G) new radio (NR), sidelink communications can include communications between user equipment (UEs) or other devices without traversing a base station or other access point. In one example, a base station can schedule sidelink resources or allocate a sidelink resource pool for the UEs to use for the sidelink communications. In general, a first UE can transmit sidelink communications to one or more second UEs, where the first UE can be referred to herein as a sidelink (SL) transmitting (Tx) UE, and the second UE can be referred to herein as a SL receiving (Rx) UE. The SL Rx UE can also transmit feedback for sidelink communications to the SL Tx UE over a sidelink feedback channel. In a specific example, the SL Tx UE can transmit, and the SL Rx UE can receive, sidelink communications over a physical sidelink control channel (PSCCH) and/or a physical sidelink shared channel (PSSCH), and the SL Rx UE can transmit, and the SL Tx UE can receive, feedback over a physical sidelink feedback channel (PSFCH). Though these specific terms are used herein to generally describe the intended functionality, other specific channels can be used as well.

In some examples, PSFCH resources can be from a resource pool, but not necessarily a dedicated PSFCH resource pool, and as such, the SL Rx UE can select PSFCH resources for transmitting feedback as described herein. For example, a parameter periodPSFCHresource can indicate a period in slots for PSFCH transmission in a resource pool. In an example, a slot can include a collection of a number of symbols, such as orthogonal frequency division multiplexing (OFDM) symbols, which can be in a unit of time (e.g., 1 millisecond (ms)) and/or may include divisions of frequency, such as multiple resource blocks (RBs) (or physical RBs (PRBs)) each having a number of resource elements (REs) or subcarriers in frequency. The supported values for periodPSFCHresource (e.g., the periods) can include 0, 1, 2, 4, where 0 can indicate no PSFCH. PSFCH transmission timing can be the first slot with PSFCH resource after PSSCH and after a specified minimum time gap parameter (MinTimeGapPSFCH) measured after receiving the PSSCH. In this example, M_{PRB,set}^{PSFCH}, or rbSetPSFCH, can define a set of PRBs for PSFCH in a slot. This can be split between N_{PSSCH}^{PSFCH} (Number of PSSCH slots corresponding to the PSFCH slot) and N_{subch} PSSCH in a slot. For example, each subchannel/slot can have

$${M}_{subch , slot}^{PSFCH} = \frac{{M}_{PRB , set}^{PSFCH}}{{N}_{PSSCH}^{PSFCH} \times {N}_{subch}}$$

PRBs. Time first mapping can apply from PSSCH resource to PSFCH PRBs. PSFCH resource pool can be of size: R_{PRB,CS}^{PSFCH}=N_{type}^{PSFCH}×N_{CS}^{PSFCH}×M_{subch,slot}^{PSFCH}, where N_{CS}^{PSFCH} is the number of cyclic shift (CS) pairs configured per resource pool (e.g., the pair is for acknowledgement (A)/negative A (N) and can be 1 bit), N_{type}^{PSFCH} can be 1 or N_{subch}^{PSSCH}. PSSCH For the subchannels in a PSSCH slot, the PSFCH resource pool may be shared or not. Within the pool, the PSFCH resource is indexed from in PRB index, then in CS pair index. In an example, PSFCH resource can be determined as: (P_{ID}+M_{ID}) mod R_{PRB,CS}^{PSFCH}, where P_{ID} is the layer 1 (L1)-identifier (ID) indicated in sidelink control information (SCI) 2-A or 2-B, and M_{ID} is 0 or groupcast ID, where the SCI is transmitted from the SL Tx UE to the SL Rx UE. For unicast or NAK based transmission, for example, M_{ID}=0, and the SL Rx UE can send A/N at a source ID dependent resource in the pool. For groupcast, where the SL Tx UE transmits a sidelink transmission to multiple SL Rx UEs, each SL Rx UE can select one resource in the pool and transmit A/N.

In accordance with aspects described herein, PSFCH can be extended to interlace waveform, similar to PSCCH/PSSCH. In an example, each PSFCH can occupy one interlace in one RB set of one or more symbols designated for PSFCH feedback. In one specific example, each PSFCH can be about 10 RBs. To exploit the 10 RB per interlace, for example, multiple bits can be carried per PSFCH transmission. For example, for interlace PF0 PSFCH can include length 12 sequence per RB with cyclic shift ramping and/or long sequence over 10 or 11 interlaces with index modulation. For example, for interlace PF2 PSFCH, OFDM waveform can be used using all RBs in the interlace. In this example, to improve user multiplexing, orthogonal cover code (OCC)2 or OCC4 can be introduced. These examples may be a special case of the multi-bit PSFCH designs.

In 5G NR, for downlink/uplink communications between a base station and UE, enhanced dynamic codebook (e.g., “Type-2 HARQ-ACK codebook grouping and HARQ-ACK retransmission”) is provided where each downlink control information (DCI) transmission from the base station can include multiple parameters for group feedback. For example, the DCI can include a value of group (g=0 or g=1) for the scheduled physical downlink shared channel (PDSCH), and counter (C)-downlink assignment index (DAI) and/or total (T)-DAI are accumulated within each PDSCH group. For example, the DCI can include NFI for the scheduled PDSCH group that operates as a toggle bit, such that when NFI is toggled, DAI for the group can be reset (A/N for a PDSCHs in a group before the reset are not transmitted; after the reset, the A/N for previous groups is considered). For example, the DCI can include a bit to indicate whether the feedback for the other group (non-scheduled group) is also requested or not. The following fields can be present in the DCI based on radio resource control (RRC) configuration (e.g., the fields can be present or absent), and can provide extra reliability in case of missing DCIs: NFI for the other group (non-scheduled group), total DAI for the other group (non-scheduled group), hybrid automatic repeat/request (HARQ)-Ack codebook, etc. For example, the total DAI for the other group may be separate from regular C-DAI (for the scheduled group) and regular T-DAI (for the scheduled group), which is present when UE is configured more than one downlink (DL) component carrier (CC). The HARQ-Ack codebook can be generated separately for each PDSCH group to yield first/second HARQ-Ack information. The values of NFI/T-DAI for the other group (if present) can be used to correct codebook size in case of one or more last DCIs for a given group are missed. The value of request field can be used so that UE knows the feedback for the other group should be included or not.

Currently, in 5G NR, A/N feedback bits are not multiplexed for SL communications. The traffic assumed is vehicle-to-anything (V2X), which can include vehicle-to-vehicle (V2V), vehicle-to-infrastructure (V2I), etc. where two UEs can communicate using sidelink communications, and A/N are reported to different transmitters. In the case that multiple A/N bits are targeting the same transmitter, the PSFCH may not be optimized and multiple PSFCH may be transmitted. A UE may be able to transmit a certain number of PSFCH in parallel. In sidelink in unlicensed band (SL-U), for example, though multiple transmitters may be transmitting to the receiving UE using a mix of unicast, groupcast, or broadcast, there may be a focus on enhanced mobile broadband (eMBB). Supporting A/N multiplexing can reduce the number of PSFCH to be transmitted in parallel, and/or may take advantage of the larger dimension PSFCH with interlaced waveform (e.g., as interlaced PFSCH waveform may have 10 or 11 RBs per interlace, as explained above).

Aspects described herein relate to mechanisms for communicating sidelink feedback by using PSFCH interlaced waveform where feedback bits can be multiplexed over PSFCH resources. For example, to exploit the multi-bit PSFCH design, an enhanced HARQ codebook can be introduced and used in SL communications. For example, the enhanced codebook can include an enhanced Type 1 codebook (CB) where, for fixed HARQ timeline, the A/N bits (or more generally, the feedback bits) in CB are associated with the PSSCH in the fixed N slots. In an example, in the enhanced Type 1 CB, and dynamic HARQ timeline, the SCI can indicate K1 from a configured subset of K1 and the enhanced Type 1 CB can include A/Ns from PSSCH slots (e.g., all of the possible PSSCH slots) indicated by K1. For example, the PSFCH transmission may failed due to failed listen-before-talk (LBT) or other clear channel assessment (CCA) process (e.g., in SL-U) or the PSFCH decoding may fail at the SL Tx UE. In any case, a Type 1 CB retransmission mechanism can be used for retransmitting feedback.

For example, using the interlaced feedback for allowing transmission of multiple feedback can allow a UE to retransmit SL feedback for one or more first transmissions along with transmitting SL feedback for one or more second transmissions. Allowing for retransmission can improve likelihood that the SL Tx UE receives the feedback, and doing so using the interlaced feedback mechanism or other mechanism that allows for transmitting multiple feedback bits in a single signal or over a single time division (e.g., symbol) can conserve feedback transmission instances, which can conserve resource usage by the UE. The above benefits may enhance the efficiency and quality of wireless communications between the UEs, which can provide improved available resources or throughput for communications, user experience at the UE, etc.

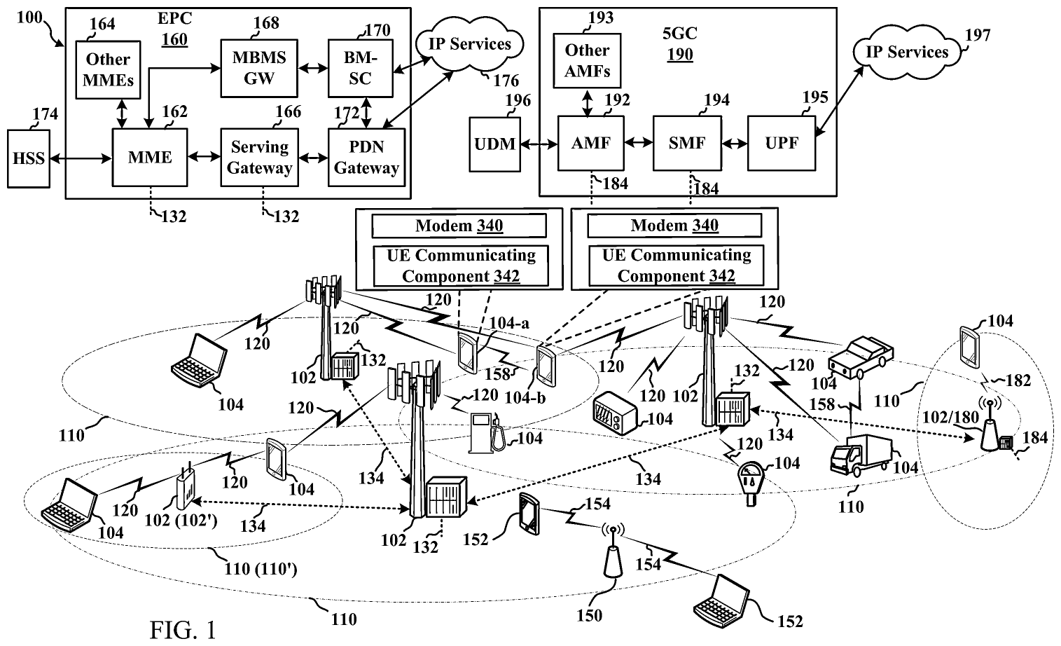

The described features will be presented in more detail below with reference to FIGS. 1-9.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and a UE communicating component 342 for sidelink communications and communicating feedback for the sidelink communications, as described further herein. Though UE 104-a and UE 104-b are shown as having the modem 340 and UE communicating component 342, this is one illustrative example, and substantially any node or type of node may include a modem 340 and UE communicating component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an SI interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs (e.g., UE 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network. In addition, in this regard, UEs 104-a, 104-b can use a portion of frequency in the 5 GHz unlicensed frequency spectrum in communicating with the small cell 102′, with other cells, with one another using sidelink communications, etc. The UEs 104-a, 104-b, small cell 102′, other cells, etc. can use other unlicensed frequency spectrums as well, such as a portion of frequency in the 60 GHz unlicensed frequency spectrum.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, in a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.), including base station 102 described above and further herein, may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as virtually distributing functionality for at least one unit, which can enable flexibility in network design. The various units of the disaggregated base station, or disaggregated RAN architecture, can be configured for wired or wireless communication with at least one other unit.

In an example, UE communicating component 342 of a first UE (e.g., UE 104-a, which can be a SL Tx UE) can transmit sidelink communications to a second UE (e.g., UE 104-b, which can be a SL Rx UE). UE communicating component 342 of a second UE can receive the sidelink communications and can generate feedback for the sidelink communications for transmitting to the SL Tx UE. For example, UE communicating component 342 of the second UE can transmit feedback that is multiplexed over feedback resources, such as PSFCH resources. For example, UE communicating component 342 of the second UE can multiplex second feedback for a second transmission received from the SL Tx UE along with a retransmission of first feedback for a first transmission received from the SL Tx UE (e.g., where the first feedback was not properly received by the SL Tx UE due to failure by the SL Rx UE in acquiring a channel in LBT, due to the SL Tx UE not being able to decode the first feedback, etc.). UE communicating component 342 of the second UE can receive and process the feedback, and can determine whether to retransmit the first transmission or the second transmission based on the feedback.

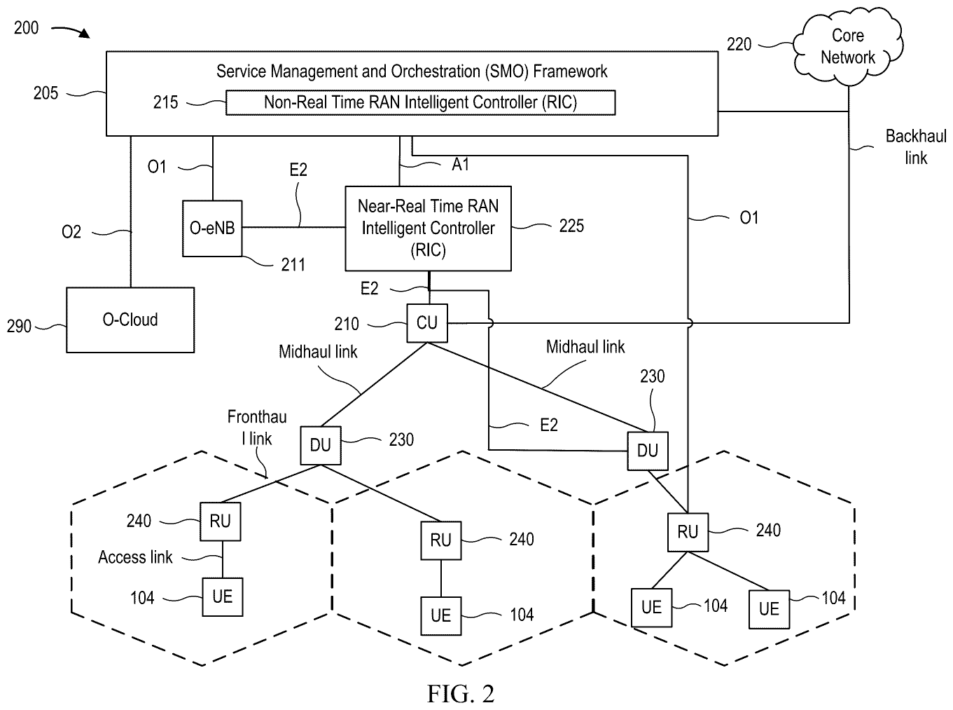

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU—UP)), control plane functionality (i.e., Central Unit-Control Plane (CU—CP)), or a combination thereof. In some implementations, the CU 210 can be logically split into one or more CU—UP units and one or more CU—CP units. The CU—UP unit can communicate bidirectionally with the CU—CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

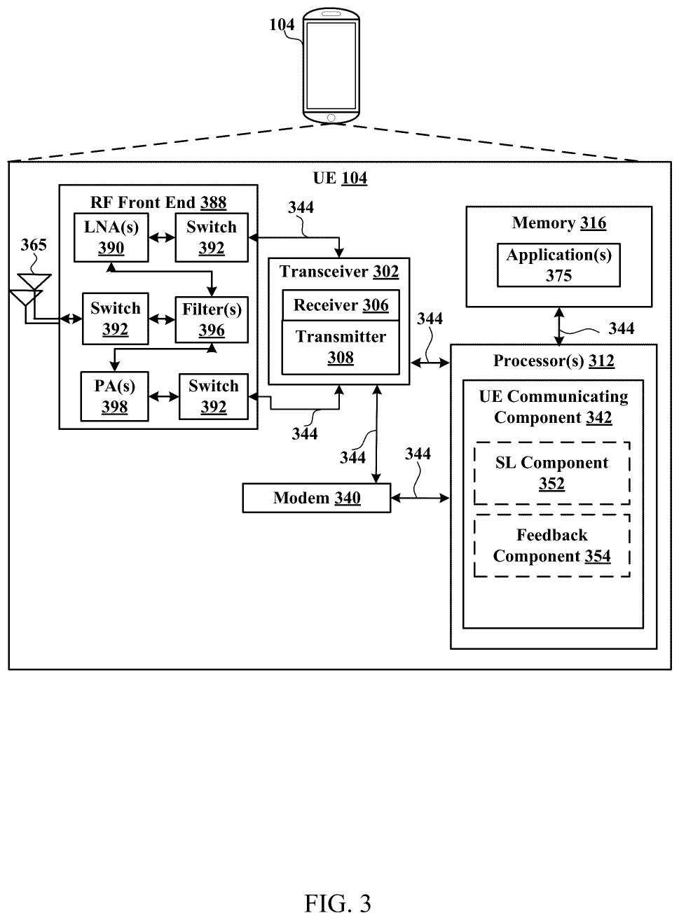

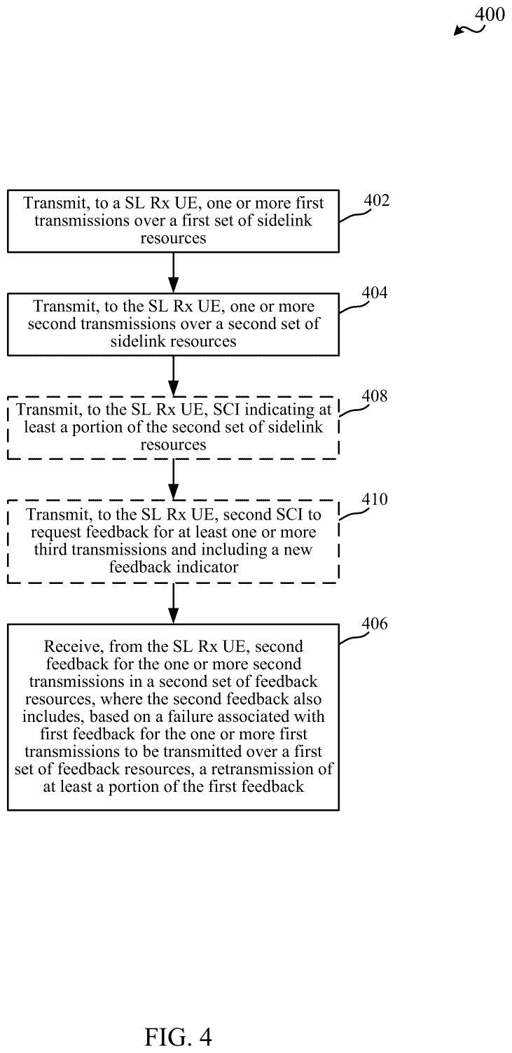

Turning now to FIGS. 3-9, aspects are depicted with reference to one or more components and one or more methods that may perform the actions or operations described herein, where aspects in dashed line may be optional. Although the operations described below in FIGS. 4-6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for sidelink communications and communicating feedback for the sidelink communications, as described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware and/or software executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102 or a SL transmitting UE. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware and/or software executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, receiving wireless communications transmitted by at least one base station 102 or a SL transmitting UE, transmitting wireless communications to at least one base station 102 or a SL receiving UE, etc. RF front end 388 may be connected to one or more antennas 365 and can include one or more low-noise amplifiers (LNAs) 390, one or more switches 392, one or more power amplifiers (PAS) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102, one or more other UEs in SL communications, etc. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a SL component 352 for transmitting or receiving SL communications, and/or a feedback component 354 for transmitting or receiving feedback for the SL communications.

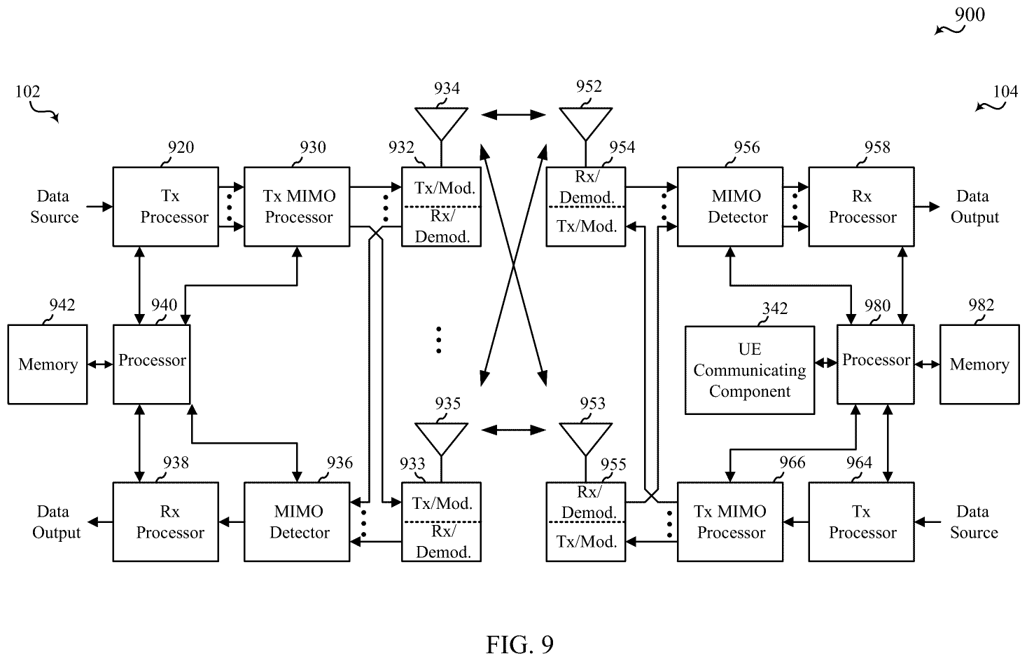

In an aspect, the processor(s) 312 may correspond to one or more of the processors described in connection with the UE in FIG. 9. Similarly, the memory 316 may correspond to the memory described in connection with the UE in FIG. 9.

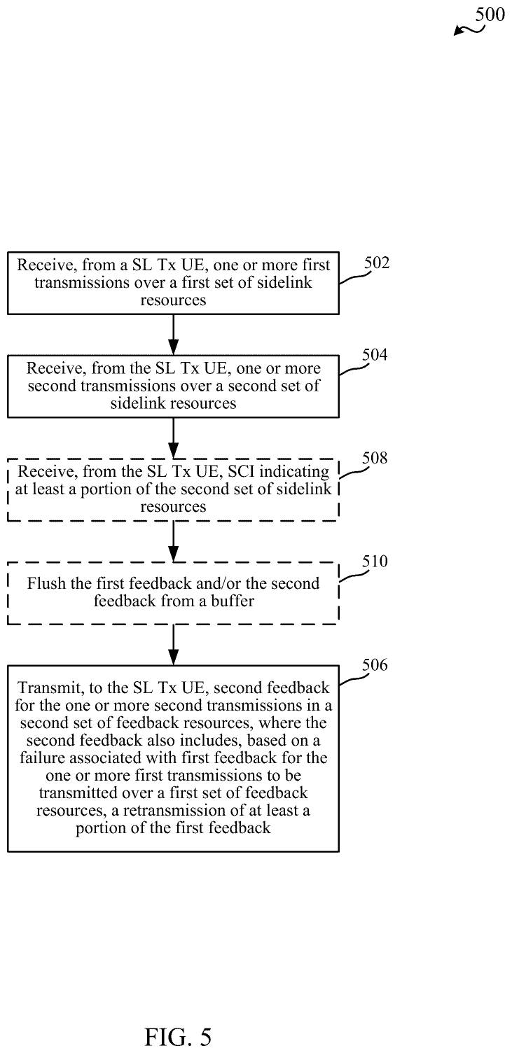

FIG. 4 illustrates a flow chart of an example of a method 400 for receiving feedback for SL communications. FIG. 5 illustrates a flow chart of an example of a method 500 for transmitting feedback for SL communications. In an example, a UE (e.g., a SL Tx UE 104-a) can perform the functions described in method 400 using one or more of the components described in FIGS. 1 and 3. In an example, a UE (e.g., a SL Rx UE 104-b) can perform the functions described in method 500 using one or more of the components described in FIGS. 1 and 3. Though described in conjunction with one another for ease of explanation, methods 400 and 500 are not required to be performed together and may be performed independently (on distinct devices or otherwise). Moreover, in some examples, a given UE 104 may be configured to perform one or both of methods 400 and/or 500 in a given scenario.

In method 400, at Block 402, one or more first transmissions can be transmitted, to a SL Rx UE, over a first set of SL resources. In an aspect, SL component 352 of a SL Tx UE 104-a, e.g., in conjunction with processor(s) 312, memory 316, transceiver 302, UE communicating component 342, etc., can transmit, to the SL Rx UE (e.g., SL Rx UE 104-b), the one or more first transmissions over the first set of SL resources. For example, the first set of SL resources can include a number of RBs in one or more symbols that are allocated for a SL channel (e.g., PSCCH, PSSCH, etc.). In one example, SL Tx UE 104-a can receive an indication of the allocation of resources from a base station (e.g., in Mode 1 allocation) or can receive an indication of a resource pool from the base station (e.g., in Mode 2 allocation) from which the SL Tx UE 104-a can select the first set of SL resources for the SL channel. In one example, SL component 352 can also transmit, to the SL Rx UE 104-b, SCI (e.g., over PSCCH) that indicates the first set of SL resources for the SL channel, which may include other information for receiving the one or more first transmissions, transmitting feedback for the one or more first transmissions, etc.

In method 500, at Block 502, one or more first transmissions can be received, from a SL Tx UE, over a first set of SL resources. In an aspect, SL component 352 of a SL Rx UE 104-b, e.g., in conjunction with processor(s) 312, memory 316, transceiver 302, UE communicating component 342, etc., can receive, from the SL Tx UE, one or more first transmissions over the first set of SL resources. In an example, SL component 352 of the SL Rx UE 104-b can receive, from the SL Tx UE 104-a, SCI (e.g., over PSCCH) indicating the first set of SL resources for the SL channel, which may include other information for receiving the one or more first transmissions, transmitting feedback for the one or more first transmissions, etc. For example, the SCI may indicate a set of feedback resources over which to transmit feedback for the one or more first transmissions, or may indicate one or more parameters for determining the set of feedback resources over which to transmit the feedback. In one example, feedback component 354 can generate feedback for the one or more first transmissions, and SL component 352 may attempt to transmit the feedback over the set of feedback resources. It is possible, however, that the SL Tx UE 104-a does not receive the feedback, which may be due to SL Rx UE 104-b not being able to successfully complete an LBT procedure before transmitting the feedback, SL Tx UE 104-a not being able to successfully decode the feedback due to radio conditions, etc. In any case, where SL Rx UE 104-b determines that the SL Tx UE 104 did not receive the feedback (or that SL Rx UE 104-b was not able to transmit the feedback), feedback component 354 of the SL Rx UE 104-b can retransmit the feedback in a subsequent set of feedback resources, and may multiplex the retransmitted feedback with other feedback, as described further herein.

In method 400, at Block 404, one or more second transmissions can be transmitted, to a SL Rx UE, over a second set of SL resources. In an aspect, SL component 352 of a SL Tx UE 104-a, e.g., in conjunction with processor(s) 312, memory 316, transceiver 302, UE communicating component 342, etc., can transmit, to the SL Rx UE (e.g., SL Rx UE 104-b), the one or more second transmissions over the second set of SL resources. For example, the second set of SL resources can include a number of RBs in one or more symbols that are allocated for a SL channel (e.g., PSCCH, PSSCH, etc.), subsequent to the first set of resources. In one example, SL Tx UE 104-a can receive an indication of the allocation of resources from a base station (e.g., in Mode 1 allocation) or can receive an indication of a resource pool from the base station (e.g., in Mode 2 allocation) from which the SL Tx UE 104-a can select the second set of SL resources for the SL channel. In one example, SL component 352 can also transmit, to the SL Rx UE 104-b, SCI (e.g., over PSCCH) that indicates the second set of SL resources for the SL channel, which may include other information for receiving the one or more second transmissions, transmitting feedback for the one or more second transmissions (and/or the one or more first transmissions), etc.

In method 500, at Block 504, one or more second transmissions can be received, from a SL Tx UE, over a first set of SL resources. In an aspect, SL component 352 of a SL Rx UE 104-b, e.g., in conjunction with processor(s) 312, memory 316, transceiver 302, UE communicating component 342, etc., can receive, from the SL Tx UE (e.g., SL Tx UE 104-a), one or more second transmissions over the second set of SL resources. In an example, SL component 352 of the SL Rx UE 104-b can receive, from the SL Tx UE 104-a, SCI (e.g., over PSCCH) indicating the second set of SL resources for the SL channel, which may include other information for receiving the one or more second transmissions, transmitting feedback for the one or more second transmissions (and/or the one or more first transmissions), etc. For example, the SCI may indicate a second set of feedback resources over which to transmit feedback for the one or more second transmissions, or may indicate one or more parameters for determining the second set of feedback resources over which to transmit the feedback. In one example, feedback component 354 can generate feedback for the one or more second transmissions, and SL component 352 may attempt to transmit the feedback over the set of feedback resources.

In method 500, at Block 506, second feedback for the one or more second transmissions can be transmitted, to the SL Tx UE, in a second set of feedback resources, where the second feedback can also include, based on a failure associated with first feedback for the one or more first transmissions to be transmitted over a first set of feedback resources, a retransmission of at least a portion of the first feedback. In an aspect, feedback component 354 of a SL Rx UE 104-b, e.g., in conjunction with processor(s) 312, memory 316, transceiver 302, UE communicating component 342, etc., can transmit, to the SL Tx UE (e.g., SL Tx UE 104-a), second feedback for the one or more second transmissions in a second set of feedback resources, where the second feedback can also include, based on a failure associated with first feedback for the one or more first transmissions to be transmitted over a first set of feedback resources, a retransmission of at least a portion of the first feedback. As described, for example, feedback component 354 of the SL Rx UE 104-b can determine that the first feedback for the one or more first transmissions was not received by the SL Tx UE 104-a (or was not transmitted by the SL Rx UE 104-b due to LBT failure or other failure), and feedback component 354 can accordingly multiplex a retransmission of the first feedback with the second feedback for the one or more second transmissions from the SL Tx UE 104-a.

In method 400, at Block 406, second feedback for the one or more second transmissions can be received, from the SL Rx UE, in a second set of feedback resources, where the second feedback can also include, based on a failure associated with first feedback for the one or more first transmissions to be transmitted over a first set of feedback resources, a retransmission of at least a portion of the first feedback. In an aspect, feedback component 354 of a SL Tx UE 104-a, e.g., in conjunction with processor(s) 312, memory 316, transceiver 302, UE communicating component 342, etc., can receive, from the SL Rx UE (e.g., SL Rx UE 104-b), second feedback for the one or more second transmissions in a second set of feedback resources, where the second feedback can also include, based on a failure associated with first feedback for the one or more first transmissions to be transmitted over a first set of feedback resources, a retransmission of at least a portion of the first feedback. As described, for example, feedback component 354 of the SL Tx UE 104-a can determine that the first feedback for the one or more first transmissions was not received from the SL Rx UE 104-b, feedback component 354 can accordingly receive and/or decode the feedback including the retransmission of the first feedback multiplexed with the second feedback for the one or more second transmissions.

In an example, SL Tx UE 104-a can indicate, in SCI for the second set of SL resources over which the one or more second transmissions are transmitted, one or more parameters indicating whether the first feedback is received or whether to retransmit the first feedback for the one or more first transmissions, etc. In method 400, optionally at Block 408, SCI indicating at least a portion of the second set of SL resources can be transmitted to the SL Rx UE. In an aspect, SL component 352 of a SL Tx UE 104-a, e.g., in conjunction with processor(s) 312, memory 316, transceiver 302, UE communicating component 342, etc., can transmit, to the SL Rx UE (e.g., SL Rx UE 104-b), the SCI indicating at least the portion of the second set of SL resources. In method 500, optionally at Block 508, SCI indicating at least a portion of the second set of SL resources can be received from the SL Tx UE. In an aspect, SL component 352 of a SL Rx UE 104-b, e.g., in conjunction with processor(s) 312, memory 316, transceiver 302, UE communicating component 342, etc., can receive, from the SL Tx UE (e.g., SL Tx UE 104-a), the SCI indicating at least the portion of the second set of SL resources. For example, this SCI can include the one or more parameters indicating whether the first feedback is received or whether to retransmit the first feedback for the one or more first transmissions, etc.

In one specific example, the transmissions can be separated into groups corresponding to the one or more transmissions, and the one or more parameters in the SCI may include group-specific indicators of the group for which the SCI is intended, indicators related to whether feedback is received for a group, etc. For example, two HARQ codebooks can be used to transmit feedback for the two sets of transmissions-one codebook for one set of transmissions (e.g., a scheduled group) and another codebook for retransmitting feedback for another set of transmissions (e.g., a non-scheduled group). In one example, the one or more parameters in the SCI may include an indication of a PSSCH group index of the scheduled group (also referred to herein as “g”), a new feedback indicator (NFI) for the scheduled group (also referred to herein as “h”), an indicator of whether feedback for the other group (e.g., the non-scheduled group) is requested (also referred to herein as “q”), a NFI for the non-scheduled group (also referred to herein as “h””), etc.

For example, the PSSCH group index (g) can be a bit indicating which group is the scheduled group (e.g., to indicate when separate feedback is to be reported). For example, the PSSCH group index can be the same in multiple consecutive SCIs, and the feedback for the corresponding transmissions can be grouped together for transmitting to the SL Tx UE 104-a. When the PSSCH group index changes, the SL Rx UE 104-b can report feedback for the previous PSSCH group of transmissions in PSFCH resources indicated by, or determined based on, the SCI. In an example, where there is a fixed timeline for reporting HARQ feedback, this PSSCH group index may be implicit as the SL Rx UE 104-b can determine when to report feedback for a group of transmissions (and thus feedback for which group of transmissions is to be included); where there is a dynamic timeline for reporting HARQ feedback (e.g., where K1 is present in the SCI to indicate the offset from the SCI, or the resources indicated in the SCI, at which to report HARQ feedback), the PSSCH group index can be included to additionally indicate the end of the previous PSSCH group (for which feedback is to be reported).

In another example, the NFI bit for the scheduled group (h) can be a bit that is toggled to indicate whether new feedback is being requested for the scheduled PSSCH group. For example, the codebook associated with the group can be reset when the NFI is toggled (e.g., when the NFI value in currently received SCI is different than the NFI value in the preceding SCI). Where the bit is toggled, for example, feedback component 354 of the SL Rx UE 104-b can remove accumulated feedback bits of the same PSSCH group from a previous PSFCH instance.

In another example, the indicator of whether feedback for the other group (the non-scheduled group) is requested (q) can be to indicate whether the HARQ feedback for the other group is also requested in the upcoming PSFCH instance or not. In another example, the NFI bit for the non-scheduled group (h′) can be present in SCI based on an RRC configuration to provide extra reliability in case the SL Rx UE 104-b misses the previous SCI for when the non-scheduled group was the scheduled group.

In this example, feedback component 354 of SL Rx UE 104-b can maintain two codebooks for two PSSCH groups, as described. For example, SL component 352 can receive the SCI at 508, and feedback component 354 can use g to determine to which codebook the feedback of the scheduled PSSCH belongs. In an example, feedback component 354 can resets the codebook associated with scheduled group (g) if h is toggled. In one example, feedback component 354 of the SL Tx UE 104-a toggles h if it detects the feedback is associated with the scheduled group in the previous PSFCH instance, or can maintain (e.g. not toggle) the h value if the SL Tx UE 104-a cannot or has not yet decoded feedback associated with the scheduled group in the previous PSFCHs (e.g., and thus the SL Rx UE 104-b can keep previous feedback associated with the scheduled group for retransmission). If q=0, feedback component 354 of the SL Rx UE 104-b can puts the codebook of the scheduled PSSCH in the indicated PSFCH. If q=1, feedback component 354 of the SL Rx UE 104-b can encode two codebooks (scheduled and non-scheduled) in the indicated PSFCH. For fixed timeline, g can be alternating across different PSFCH periods, and thus may not be indicated by the SCI.

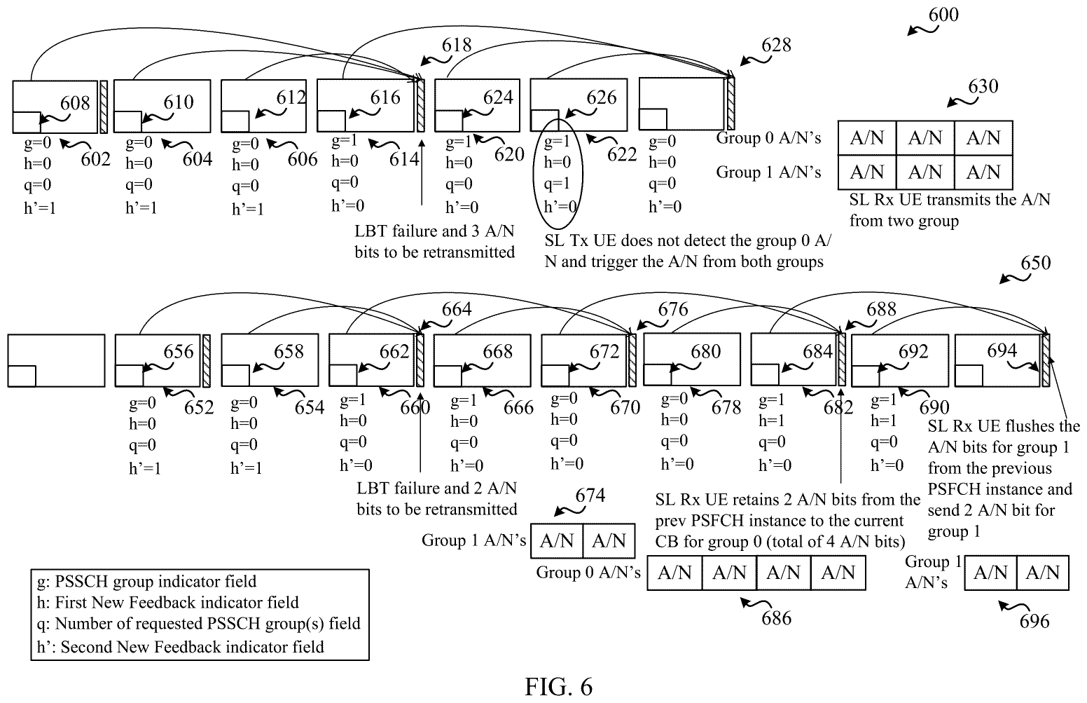

FIG. 6 illustrates examples of timelines 600, 650 for transmitting feedback for groups of SL transmissions. In timeline 600, for example, the SL Tx UE 104-a can transmit PSSCH 602, 604, 606, which respectively include SCI 608, 610, 612. SCI 608, 610, 612 can indicate group g=0 as the scheduled group (and feedback for transmissions over resources corresponding to consecutive SCIs having g=0 can be grouped for transmitting in a PSFCH instance). Thus, SL component 352 of the SL Tx UE 104-a can transmit the PSSCHs 602, 604, 606, along with the corresponding SCIs 608, 610, 612. SL component 352 of the SL Rx UE 104-b can receive the PSSCHs 602, 604, 606, along with the corresponding SCIs 608, 610, 612. SL component 352 of the SL Tx UE 104-a can transmit the PSSCH 614 along with the corresponding SCI 616, which can indicate a new group g=1. SL component 352 of the SL Rx UE 104-b can receive the PSSCH 614 along with the corresponding SCI 616 indicating the new group g=1, and feedback component 354 of the SL Rx UE 104-b can accordingly determine to group the feedback for PSSCHs 602, 604, 606, and attempt to transmit the feedback at PSFCH instance 618. Transmission of the feedback at PSFCH instance 618 may fail due to failed LBT, due to the SL Tx UE 104-a not being able to receive the feedback, or other reasons. In any case, SL Tx UE 104-a can indicate, in SCI, that the feedback was not received.

For example, SL component 352 of the SL Tx UE 104-a can also transmit the PSSCHs 620, 622 along with the corresponding SCIs 624, 626, which can indicate the new group g=1 as well, and one or more of the SCIs, 624, 626 for the new group (e.g., SCI 626 as the latest SCI) can specify q=1 to indicate that the SL Tx UE did not detect the feedback for group g=0 and/or to trigger both feedback transmission for group g=1 and feedback retransmission for group g=0 in the next PSFCH instance 628. As described, SL component 352 of the SL Rx UE 104-b can receive SCI 626 with the q=1, and feedback component 354 of the SL Rx UE 104-b can accordingly determine to multiplex retransmission of the feedback for group g=0 (the non-scheduled group) with feedback for the group g=1 (the scheduled group), as shown at 630 (where “A/N” can represent an ACK or NACK feedback bit for a corresponding PSSCH transmission.

In timeline 650, for example, the SL Tx UE 104-a can transmit PSSCH 652, 654, which respectively include SCI 656, 658. SCI 656, 658 can indicate group g=0 as the scheduled group (and feedback for transmissions over resources corresponding to consecutive SCIs having g=0 can be grouped for transmitting in a PSFCH instance). Thus, SL component 352 of the SL Tx UE 104-a can transmit the PSSCHs 652, 654, along with the corresponding SCIs 656, 658. SL component 352 of the SL Rx UE 104-b can receive the PSSCHs 652, 654, along with the corresponding SCIs 656, 658. SL component 352 of the SL Tx UE 104-a can transmit the PSSCH 660 along with the corresponding SCI 662, which can indicate a new group g=1. SL component 352 of the SL Rx UE 104-b can receive the PSSCH 660 along with the corresponding SCI 662 indicating the new group g=1, and feedback component 354 of the SL Rx UE 104-b can accordingly determine to group the feedback for PSSCHs 652, 654, and attempt to transmit the feedback at PSFCH instance 664. Transmission of the feedback at PSFCH instance 664 may fail due to failed LBT, due to the SL Tx UE 104-a not being able to receive the feedback, or other reasons. In any case, SL Tx UE 104-a can indicate, in SCI, that the feedback was not received. In this example, feedback component 354 of the SL Rx UE 104-b can retain the feedback for retransmitting in a next PSFCH instance for group g=0.

For example, SL component 352 of the SL Tx UE 104-a can also transmit the PSSCH 666 along with the corresponding SCI 668, which can indicate the new group g=1 as well. SL component 352 of the SL Tx UE 104-a can transmit the PSSCH 670 along with the corresponding SCI 672, which can indicate a new group g=0. SL component 352 of the SL Rx UE 104-b can receive the PSSCH 670 along with the corresponding SCI 672 indicating the new group g=0, and feedback component 354 of the SL Rx UE 104-b can accordingly determine to group the feedback for PSSCHs 660, 666 corresponding to group g=1, and transmit the feedback (shown as Group 1 A/N's 674) at PSFCH instance 676. For example, SL component 352 of the SL Tx UE 104-a can also transmit the PSSCH 678 along with the corresponding SCI 680, which can indicate the group g=0 as well. SL component 352 of the SL Tx UE 104-a can transmit the PSSCH 682 along with the corresponding SCI 684, which can indicate a new group g=1. SL component 352 of the SL Rx UE 104-b can receive the PSSCH 682 along with the corresponding SCI 684 indicating the new group g=1, and feedback component 354 of the SL Rx UE 104-b can accordingly determine to group the feedback for PSSCHs 670, 678 corresponding to group g=0. In an example, feedback component 354 can also detect the previous feedback for group g=0 that was not received by the SL Tx UE 104-a. In one example, feedback component 354 can determine to retransmit the previous feedback for the group g=0 based on the h bit not being toggled to h=1 in SCIs 672, 680. Feedback component 354 can accordingly include a retransmission of the previous feedback with the current feedback for group g=0. Feedback component 354 can accordingly transmit the feedback for group g=0 (shown as Group 0 A/N's 686) at PSFCH instance 688.

For example, SL component 352 of the SL Tx UE 104-a can also transmit the PSSCH 690 along with the corresponding SCI 692, which can indicate the new group g=1 as well. Based on the SCI(s) 684, 692 toggling h=1 (from previous h=0) for group g=1, feedback component 354 can determine to flush the feedback for the previous PSSCHs for group g=1. Thus, in the next PSFCH instance 694 for group g=1, feedback component 354 of the SL Rx UE 104-b can transmit feedback for PSSCHs 682, 690 (indicated as Group 1 A/N's 696) without retransmitting previous feedback for group g=1.

In method 500, optionally at Block 510, the first feedback and/or the second feedback can be flushed from a buffer. In an aspect, feedback component 354 of a SL Rx UE 104-b, e.g., in conjunction with processor(s) 312, memory 316, transceiver 302, UE communicating component 342, etc., can flush the first feedback and/or the second feedback from the buffer. For example, feedback component 354 can flush the first feedback and/or the second feedback from the buffer based on transmitting the feedback and/or based on one or more of the parameter values in SCI, such as whether the h bit is toggled, as described above.

In method 400, optionally at Block 410, the first feedback and/or the second feedback can be flushed from a buffer. In an aspect, feedback component 354 of a SL Rx UE 104-b, e.g., in conjunction with processor(s) 312, memory 316, transceiver 302, UE communicating component 342, etc., can flush the first feedback and/or the second feedback from the buffer. For example, feedback component 354 can flush the first feedback and/or the second feedback from the buffer based on transmitting the feedback and/or based on one or more of the parameter values in SCI, such as whether the h bit is toggled, as described above.

In another example, feedback component 354 of SL Rx UE 104-b can maintain one codebook for feedback that may allow for some level of codebook retransmission. For example, the SL component 352 of the SL Tx UE 104-a can transmit SCI to the SL Rx UE 104-b that includes a trigger for codebook retransmission in a next PSFCH instance. For example, the SCI can indicate the next PSFCH instance or one or more parameters for determining (or computing, e.g., using an offset) the next PSFCH instance. Thus, in one example, the SCI transmitted by the SL Tx UE 104-a at Block 408, and/or received by the SL Rx UE 104-b at Block 508, can include the trigger for codebook retransmission for feedback corresponding to the one or more first transmissions (e.g., where the SL Tx UE 104-a does not receive the first transmission of the feedback).

In one example, the SCI can include an explicit trigger associated with a next PSFCH instance. For example, where the SL Tx UE 104-a does not detect the PSFCH from the PSFCH instance, SL component 352 can include, in any SCI associated with the next PSFCH instance, an explicit trigger to retransmit feedback scheduled for the previous PSFCH instance. In an example, the SCI may include a first stage SCI (SCI-1) or second stage SCI (SCI-2), etc. Where the SL Rx UE 104-b receives the retransmission trigger, feedback component 354 can include (e.g., append) the retransmitted feedback with the codebook associated with the next PSFCH instance. In this example, it is possible that the feedback may be retransmitted once, without accumulation of retransmission feedback for more than one PSFCH instance. In addition, for example, as the retransmission trigger is to be sent after the previous PSFCH instance and can allow some processing time, the SL Tx UE 104-a may set the trigger if the PSFCH period is shorter than a threshold duration, where the PSFCH shorter than the threshold duration may result in the SL Tx UE 104-a not being able to process PSFCH fast enough for the next PSFCH instance.

In another example, the SCI can include a NFI that the feedback component 354 of the SL Tx UE 104-a can set (or toggle), for a PSFCH instance, when feedback is properly received and/or decoded for a previous PSFCH instance. For example, where the SL Tx UE 104-a does not detect the PSFCH from the PSFCH instance, SL component 352 of the SL Tx UE 104-a can maintain (e.g., not toggle) the NFI in transmitting the SCI-2 associated with the next PSFCH instance. SL component 352 of the SL Rx UE 104-b can receive the SCI with the NFI unchanged (e.g., not toggled) and can accordingly determine that retransmission of feedback associated with the previous PSFCH instance is being requested. Feedback component 354 of the SL Rx UE 104-b can, based on the bit being unchanged, append all the codebooks from the previous (one or more) continuous PSFCH instances with the same sign of NFI to the codebook associated with the current PSFCH. Where the NFI in the SCI is changed (e.g., toggled) from the last received NFI, feedback component 354 of the SL Rx UE 104-b can flush the retransmission feedback bits associated with previous and continuous PSFCH instances (e.g., PSFCH instances associated with the same NFI) and can send new feedback bits in the scheduled PSFCH instance. As described, the SL Rx UE 104-b can determine the NFI changing (e.g., toggling) based on the SCIs after the PSFCH or the last received SCI grant. The SCI having the NFI (or having the NFI toggled) may occur a number of symbols, X, after PSFCH, as the SL Tx UE 104-a may introduce some processing time for PSFCH detection and sending the indication bit in SCI.

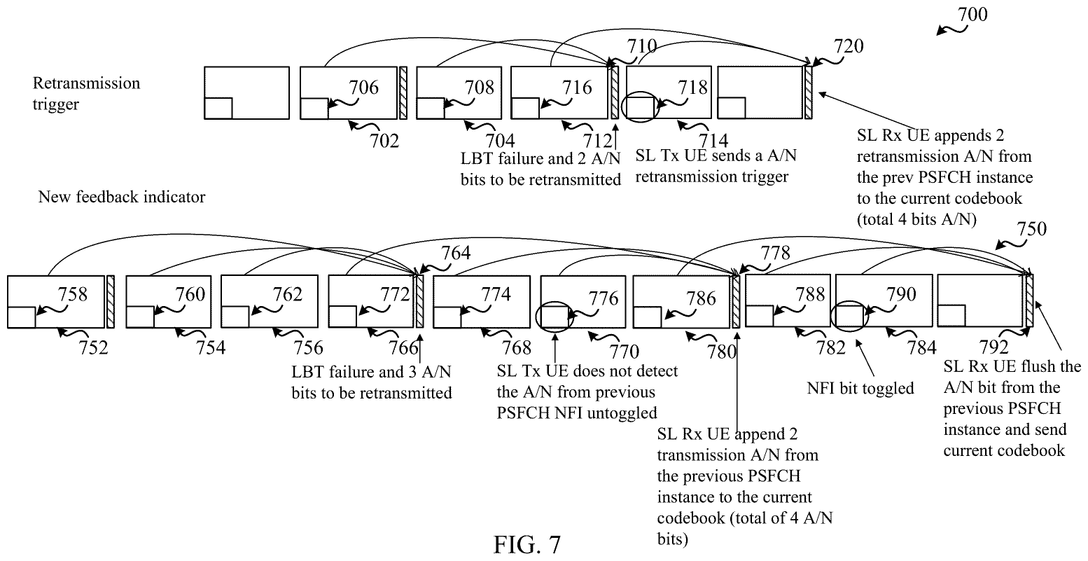

FIG. 7 illustrates examples of timelines 700, 750 for transmitting feedback based on retransmission indicators. In timeline 700, for example, a retransmission trigger in SCI can be used to signal a request for retransmitting the feedback. For example, the SL Tx UE 104-a can transmit PSSCH 702, 704, which respectively include SCI 706, 708. SL component 352 of the SL Rx UE 104-b can receive the PSSCHs 702, 704, along with the corresponding SCIs 706, 708, and feedback component 354 of the SL Rx UE 104-b can determine that the PSSCHs 702, 704 are associated with PSFCH instance 710 (e.g., based on an offset from the PSSCHs 702, 704, an indication in SCIs 706, 708, etc.). Feedback component 354 can attempt to transmit the feedback for PSSCHs 702, 704 at PSFCH instance 710, which may fail due to LBT failure or other failure such that the SL Tx UE 104-a does not properly receive the feedback, as described. SL component 352 of the SL Tx UE 104-a can transmit the PSSCH 712, 714 along with the corresponding SCI 716, 718. Feedback component 354 of the SL Tx UE 104-a can generate the SCI 718 to include a parameter that is a retransmission trigger to trigger retransmission of the last feedback—the feedback for PSSCHs 702, 704—in a next PSFCH instance. SL component 352 of the SL Rx UE 104-b can receive the PSSCHs 712, 714, along with the corresponding SCIs 716, 718, and feedback component 354 of the SL Rx UE 104-b can determine that the PSSCHs 712, 714 are associated with PSFCH instance 720 (e.g., based on an offset from the PSSCHs 712, 714, an indication in SCIs 716, 718, etc.). Feedback component 354 can also determine to include the retransmission of the previous feedback for PSSCHs 702, 704 with the feedback for PSSCHs 712, 714, and can accordingly multiplex or append the previous feedback to the codebook indicating the current feedback. Feedback component 354 can transmit the feedback for PSSCHs 702, 704, 712, and 714 at PSFCH instance 720.

In timeline 750, for example, a NFI in SCI can be used to signal a request for retransmitting the feedback. For example, the SL Tx UE 104-a can transmit PSSCH 752, 754, 756 which respectively include SCI 758, 760, 762. SL component 352 of the SL Rx UE 104-b can receive the PSSCHs 752, 754, 756, along with the corresponding SCIs 758, 760, 762, and feedback component 354 of the SL Rx UE 104-b can determine that the PSSCHs 752, 754, 756 are associated with PSFCH instance 764 (e.g., based on an offset from the PSSCHs 752, 754, 756, an indication in SCIs 758, 760, 762, etc.). Feedback component 354 can attempt to transmit the feedback for PSSCHs 752, 754, 756 at PSFCH instance 764, which may fail due to LBT failure or other failure such that the SL Tx UE 104-a does not properly receive the feedback, as described. SL component 352 of the SL Tx UE 104-a can transmit the PSSCH 766, 768, 770 along with the corresponding SCI 772, 774, 776. Feedback component 354 of the SL Tx UE 104-a can generate the SCI 776 (e.g., as the latest SCI associated with the next PSFCH instance 778) to include a NFI that remains not toggled to indicate that the last feedback—the feedback for PSSCHs 766, 768, 770—was not received (and/or as a request for retransmission of the feedback) in a next PSFCH instance. SL component 352 of the SL Rx UE 104-b can receive the PSSCHs 766, 768, 770, along with the corresponding SCIs 772, 774, 776, and feedback component 354 of the SL Rx UE 104-b can determine that the PSSCHs 766, 768, 770 are associated with PSFCH instance 778 (e.g., based on an offset from the PSSCHs 766, 768, 770, an indication in SCIs 772, 774, 776, etc.). Feedback component 354 can also determine to include the retransmission of the previous feedback for PSSCHs 752, 754, 756 with the feedback for PSSCHs 766, 768, 770, and can accordingly multiplex or append the previous feedback to the codebook indicating the current feedback. Feedback component 354 can transmit the feedback for PSSCHs 752, 754, 756, 766, 768, 770 at PSFCH instance 778.

SL component 352 of the SL Tx UE 104-a can transmit the PSSCH 780, 782, 784 along with the corresponding SCI 786, 788, 790. Feedback component 354 of the SL Tx UE 104-a can generate the SCI 790 (e.g., as the latest SCI associated with the next PSFCH instance 792) to include a NFI that is toggled to indicate that the last feedback was received (and a retransmission is not requested) in a next PSFCH instance. SL component 352 of the SL Rx UE 104-b can receive the PSSCHs 780, 782, 784, along with the corresponding SCIs 786, 788, 790, and feedback component 354 of the SL Rx UE 104-b can determine that the PSSCHs 780, 782, 784 are associated with PSFCH instance 792 (e.g., based on an offset from the PSSCHs 780, 782, 784, an indication in SCIs 786, 788, 790, etc.). Feedback component 354 can also determine, based on the toggled NFI in SCI 776, that the feedback for PSSCHs 766, 768, 770 (and 752, 754, 756), was received and retransmission is not requested. Feedback component 354 can accordingly transmit the codebook of feedback for PSSCHs 780, 782, 784 at PSFCH instance 792, and may flush the last feedback for PSSCHs 766, 768, 770 (and 752, 754, 756) from a buffer.

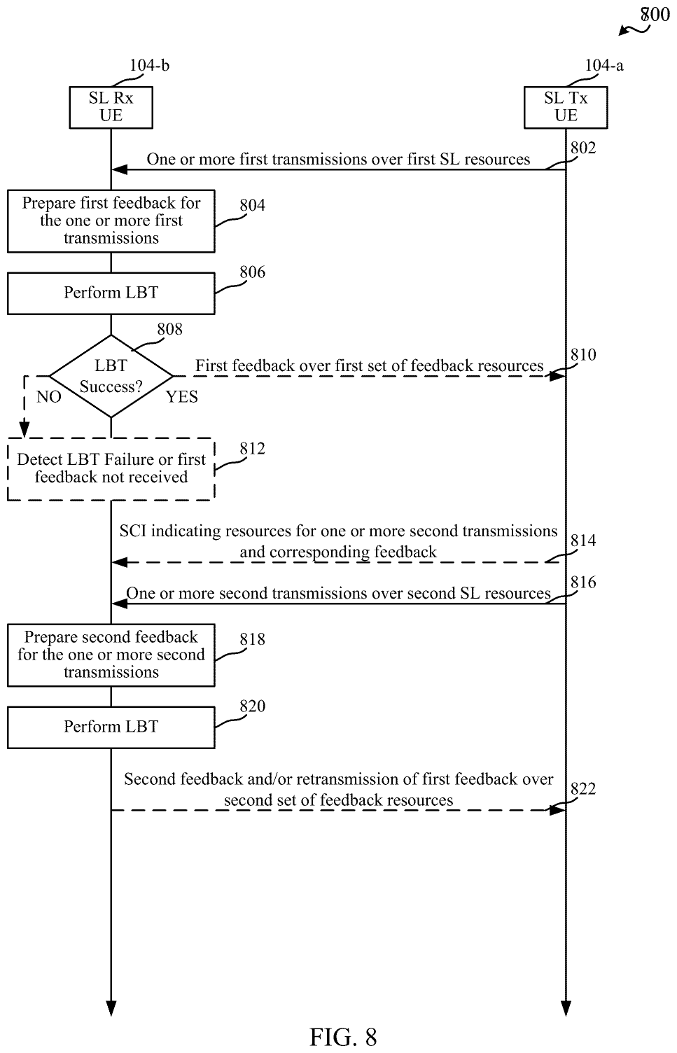

FIG. 8 illustrates an example of a call flow 800 of communications between a SL Tx UE 104-a and a SL Rx UE 104-b, in accordance with some aspects described herein. In an example, SL Tx UE 104-a may transmit, to the SL Rx UE 104-b, one or more first transmission over first SL resources at 802. For example, the one or more transmissions may include one or more PSSCH transmissions, and SL Tx UE 104-a may also transmit, to the SL Rx UE 104-b, SCI to indicate resources over which the one or more PSSCH transmissions are transmitted. SL Rx UE 104-b can prepare first feedback for the one or more first transmissions at 804. SL Rx UE 104-b may also determine resources for a PSFCH instance for transmitting the first feedback. SL Rx UE 104-b can perform LBT at 806 to acquire a channel for transmitting the first feedback in a PSFCH instance. If the LBT is successful, at 808, SL Rx UE 104-b can transmit the first feedback to the SL Tx UE 104-b over a first set of feedback resources at 810.

As described, however, SL Rx UE 104-b can detect that the first feedback is not transmitted or is not received by the SL Tx UE 104-a. For example, SL Rx UE 104-b can detect LBT failure or that the first feedback is not received at 812. In another example, SL Tx UE 104-a can transmit, to the SL Rx UE 104-b, SCI indicating resources for one or more second transmissions and corresponding feedback at 814. As described, the SCI may include one or more parameters to indicate that previous feedback was or was not received (and/or to indicate a request for retransmission of the previous feedback), such as a NFI (e.g., h, h′, etc.), a q value, an explicit retransmission indicator, etc., as described above.

In an example, SL Tx UE 104-a may transmit, to the SL Rx UE 104-b, one or more second transmission over second SL resources at 816, which may be in resources indicated in the SCI transmitted at 814. SL Rx UE 104-b can prepare second feedback for the one or more first transmissions at 818. SL Rx UE 104-b may also determine resources for a PSFCH instance for transmitting the second feedback. SL Rx UE 104-b can perform LBT at 820 to acquire a channel for transmitting the second feedback in a PSFCH instance. SL Rx UE 104-b can transmit the second feedback and/or retransmission of the first feedback to the SL Tx UE 104-b over a second set of feedback resources at 822. For example, SL Rx UE 104-b can include retransmission of the first feedback where SCI indicates to retransmit the first feedback, whether based on group-based parameters, explicit retransmission indicators, etc., as described above.

In another example, the second set of feedback resources over which the feedback component 354 of the SL Rx UE 104-b transmits the second feedback and the retransmission of the first feedback (and over which the feedback component 354 of the SL Tx UE 104-a receives the second feedback and the retransmission of the first feedback) may include different subsets of feedback resources, which may be at different PSFCH instances. For example, sidelink may allow parallel PSFCH, and feedback component 354 of the SL Rx UE 104-b (and/or the SL Tx UE 104-a) can use a hashing rule that maps the retransmitted feedback (e.g., whether as explicitly requested retransmitted feedback or as feedback for a non-scheduled group) to a different PSFCH resources or instance. For example, PSFCH resource for the scheduled codebook can be determined as: (P_{ID}+M_{ID}) mod R_{PRB,CS}^{PSFCH}, as described above, and PSFCH resource for retransmitted feedback or non-scheduled codebook can be determined as: (P_{ID}+M_{ID}+K) mod R_{PRB,CS}^{PSFCH}, where K is an offset defined for retransmitted feedback or non-scheduled codebook. In this example, (e.g., at Block 506) feedback component 354 of the SL Rx UE 104-b can transmit the second feedback over the subset of PSFCH resources (e.g., the PSFCH instance or resources) defined for the scheduled codebook and can transmit the retransmission of the first feedback over the subset of PSFCH resources (e.g., the PSFCH instance or resources) defined for the retransmitted feedback or non-scheduled codebook. Similarly, in this example (e.g., at Block 406) feedback component 354 of the SL Tx UE 104-a can receive the second feedback over the subset of PSFCH resources (e.g., the PSFCH instance or resources) defined for the scheduled codebook and can receive the retransmission of the first feedback over the subset of PSFCH resources (e.g., the PSFCH instance or resources) defined for the retransmitted feedback or non-scheduled codebook.

FIG. 9 is a block diagram of a MIMO communication system 900 including a base station 102 and a UE 104, in accordance with various aspects of the present disclosure. The MIMO communication system 900 may illustrate aspects of the wireless communication access network 100 described with reference to FIG. 1. The base station 102 may be an example of aspects of the base station 102 described with reference to FIG. 1. In addition, the UE 104 can communicate with another UE over sidelink resources using similar functionality described herein with respect to UE 104 and base station 102 communications, and as such, base station 102 could be another UE 104 having a UE communicating component 342.

The base station 102 may be equipped with antennas 934 and 935, and the UE 104 may be equipped with antennas 952 and 953. In the MIMO communication system 900, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 920 may receive data from a data source. The transmit processor 920 may process the data. The transmit processor 920 may also generate control symbols or reference symbols. A transmit MIMO processor 930 may perform spatial processing (e.g., precoding) on data symbols, control symbols, or reference symbols, if applicable, and may provide output symbol streams to the transmit modulator/demodulators 932 and 933. Each modulator/demodulator 932 through 933 may process a respective output symbol stream (e.g., for OFDM, etc.) to obtain an output sample stream. Each modulator/demodulator 932 through 933 may further process (e.g., convert to analog, amplify, filter, and upconvert) the output sample stream to obtain a DL signal. In one example, DL signals from modulator/demodulators 932 and 933 may be transmitted via the antennas 934 and 935, respectively.

The UE 104 may be an example of aspects of the UEs 104 described with reference to FIGS. 1-2. At the UE 104, the UE antennas 952 and 953 may receive the DL signals from the base station 102 and may provide the received signals to the modulator/demodulators 954 and 955, respectively. Each modulator/demodulator 954 through 955 may condition (e.g., filter, amplify, downconvert, and digitize) a respective received signal to obtain input samples. Each modulator/demodulator 954 through 955 may further process the input samples (e.g., for OFDM, etc.) to obtain received symbols. A MIMO detector 956 may obtain received symbols from the modulator/demodulators 954 and 955, perform MIMO detection on the received symbols, if applicable, and provide detected symbols. A receive (Rx) processor 958 may process (e.g., demodulate, deinterleave, and decode) the detected symbols, providing decoded data for the UE 104 to a data output, and provide decoded control information to a processor 980, or memory 982.

The processor 980 may in some cases execute stored instructions to instantiate a UE communicating component 342 (see e.g., FIGS. 1 and 3). In addition, in an example, UE 104 can be a sidelink transmitting UE, as described herein, and can use the components described herein to communicate with a sidelink receiving UE. In addition, in another example, UE 104 can be a sidelink receiving UE, as described herein, and can use the components described herein to communicate with a sidelink transmitting UE.

On the uplink (UL), at the UE 104, a transmit processor 964 may receive and process data from a data source. The transmit processor 964 may also generate reference symbols for a reference signal. The symbols from the transmit processor 964 may be precoded by a transmit MIMO processor 966 if applicable, further processed by the modulator/demodulators 954 and 955 (e.g., for SC-FDMA, etc.), and be transmitted to the base station 102 in accordance with the communication parameters received from the base station 102. At the base station 102, the UL signals from the UE 104 may be received by the antennas 934 and 935, processed by the modulator/demodulators 932 and 933, detected by a MIMO detector 936 if applicable, and further processed by a receive processor 938. The receive processor 938 may provide decoded data to a data output and to the processor 940 or memory 942.

The components of the UE 104 may, individually or collectively, be implemented with one or more application specific integrated circuits (ASICs) adapted to perform some or all of the applicable functions in hardware. Each of the noted modules may be a means for performing one or more functions related to operation of the MIMO communication system 900. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 900.

The following aspects are illustrative only and aspects thereof may be combined with aspects of other embodiments or teaching described herein, without limitation.

Aspect 1 is a method for wireless communication at a sidelink receiving UE including receiving, from a sidelink transmitting UE, one or more first transmissions over a first set of sidelink resources, receiving, from the sidelink transmitting UE, one or more second transmissions over a second set of sidelink resources, and transmitting, to the sidelink transmitting UE, second feedback for the one or more second transmissions in a second set of feedback resources, where the second feedback also includes, based on a failure associated with first feedback for the one or more first transmissions to be transmitted over a first set of feedback resources, a retransmission of at least a portion of the first feedback.

In Aspect 2, the method of Aspect 1 includes receiving, from the sidelink transmitting UE, sidelink control information indicating at least a portion of the second set of sidelink resources, where the sidelink control information includes an indication of a request for feedback for multiple groups of sidelink resources, and where transmitting the second feedback with the retransmission of at least the portion of the first feedback is based at least in part on the indication.

In Aspect 3, the method of Aspect 2 includes where the sidelink control information further includes a new feedback indicator for at least one of the multiple groups of sidelink resources, and where transmitting the second feedback with the retransmission of at least the portion of the first feedback is further based at least in part on the new feedback indicator.

In Aspect 4, the method of any of Aspects 2 or 3 includes where the sidelink control information includes a group indicator indicating that the second feedback for the one or more second transmissions is associated with a second group, where the first feedback is indicated as associated with a first group.

In Aspect 5, the method of any of Aspects 2 to 4 includes maintaining a first codebook for the first group of the multiple groups of sidelink resources, and maintaining a second codebook or the second group of the multiple groups of sidelink resources, where transmitting the second feedback includes transmitting the second feedback based on the second codebook and based at least in part on the group indicator indicating that the second feedback is associated with the second group.

In Aspect 6, the method of Aspect 5 includes resetting the second codebook based at least in part on transmitting the second feedback.

In Aspect 7, the method of any of Aspects 1 to 6, includes receiving, from the sidelink transmitting UE, sidelink control information indicating at least a portion of the second set of sidelink resources, where the sidelink control information includes an indication to trigger the retransmission in the second set of feedback resources, and where transmitting the second feedback with the retransmission of at least the portion of the first feedback is based at least in part on the indication.

In Aspect 8, the method of Aspect 7 includes where transmitting the second feedback with the retransmission includes appending at least the portion of the first feedback to the second feedback based on a codebook associated with the second set of feedback resources.

In Aspect 9, the method of any of Aspects 1 to 8 includes receiving, from the sidelink transmitting UE, sidelink control information indicating at least a portion of the second set of sidelink resources, where the sidelink control information includes an indication of whether feedback is received, and where transmitting the second feedback with the retransmission of at least the portion of the first feedback is based at least in part on the indication not being set.

In Aspect 10, the method of Aspect 9 includes where transmitting the second feedback with the retransmission includes appending at least the portion of the first feedback to the second feedback based on a codebook associated with the second set of feedback resources.

In Aspect 11, the method of any of Aspects 9 or 10 includes receiving, from the sidelink transmitting UE, sidelink control information indicating at least a portion of a third set of sidelink resources, where the sidelink control information includes a second indication that feedback is received, and flushing the first feedback and the second feedback from a buffer based on the second indication.

In Aspect 12, the method of any of Aspects 9 to 11 includes detecting whether the indication is set based on comparing the indication to a last received indication in sidelink control information for the first set of sidelink resources.

In Aspect 13, the method of any of Aspects 1 to 12 includes where the second set of sidelink resources includes a first subset for the retransmission of the first feedback and a second subset for the second feedback.

Aspect 14 is a method for wireless communication at a sidelink transmitting UE including transmitting, to a sidelink receiving UE, one or more first transmissions over a first set of sidelink resources, transmitting, to the sidelink receiving UE, one or more second transmissions over a second set of sidelink resources, and receiving, from the sidelink receiving UE, second feedback for the one or more second transmissions in a second set of feedback resources, where the second feedback also includes, based on a failure associated with first feedback for the one or more first transmissions to be transmitted over a first set of feedback resources, a retransmission of at least a portion of the first feedback.

In Aspect 15, the method of Aspect 14 includes transmitting, to the sidelink receiving UE, sidelink control information indicating at least a portion of the second set of sidelink resources, where the sidelink control information includes an indication of a request for feedback for multiple groups of sidelink resources, and where receiving the second feedback with the retransmission of at least the portion of the first feedback is based at least in part on the indication.

In Aspect 16, the method of Aspect 15 includes where the sidelink control information further includes a new feedback indicator for at least one of the multiple groups of sidelink resources, and where receiving the second feedback with the retransmission of at least the portion of the first feedback is further based at least in part on the new feedback indicator.

In Aspect 17, the method of Aspect 16 includes transmitting, to the sidelink receiving UE, second sidelink control information to request feedback for at least one or more third transmissions, where the second sidelink control information includes the new feedback indicator set based on whether the first feedback and second feedback are successfully received.

In Aspect 18, the method of any of Aspects 15 to 17 includes where the sidelink control information includes a group indicator indicating that the second feedback for the one or more second transmissions is associated with a second group, where the first feedback is indicated as associated with a first group.

In Aspect 19, the method of Aspect 18 includes transmitting, to the sidelink receiving UE, second sidelink control information to request feedback for at least one or more third transmissions, where the second sidelink control information includes the group indicator set based on whether the first feedback and second feedback are successfully received.

In Aspect 20, the method of any of Aspects 14 to 19 includes transmitting, to the sidelink receiving UE, sidelink control information indicating at least a portion of the second set of sidelink resources, where the sidelink control information includes an indication to trigger the retransmission in the second set of feedback resources, and where receiving the second feedback with the retransmission of at least the portion of the first feedback is based at least in part on the indication.

In Aspect 21, the method of Aspect 20 includes where the indication to trigger retransmission is set based on a timeline of the first set of feedback resources.

In Aspect 22, the method of any of Aspects 20 or 21 includes where receiving the second feedback with the retransmission includes receiving the second feedback with at least the portion of the first feedback appended to the second feedback based on a codebook associated with the second set of feedback resources.

In Aspect 23, the method of any of Aspects 14 to 22 includes transmitting, to the sidelink receiving UE, sidelink control information indicating at least a portion of the second set of sidelink resources, where the sidelink control information includes an indication of whether feedback is received, and where receiving the second feedback with the retransmission of at least the portion of the first feedback is based at least in part on the indication not being set.

In Aspect 24, the method of Aspect 23 includes where receiving the second feedback with the retransmission includes receiving the second feedback with at least the portion of the first feedback appended to the second feedback based on a codebook associated with the second set of feedback resources.

In Aspect 25, the method of any of Aspects 14 to 24 includes where the second set of sidelink resources includes a first subset for the retransmission of the first feedback and a second subset for the second feedback.

Aspect 26 is an apparatus for wireless communication including a transceiver, a memory configured to store instructions, and one or more processors communicatively coupled with the memory and the transceiver, where the one or more processors are configured to execute the instructions to cause the apparatus to perform one or more of the methods of any of Aspects 1 to 25.

Aspect 27 is an apparatus for wireless communication including means for performing one or more of the methods of any of Aspects 1 to 25.

Aspect 28 is a computer-readable medium including code executable by one or more processors for wireless communications, the code including code for performing one or more of the methods of any of Aspects 1 to 25.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the transceiver and the memory, wherein the one or more processors are configured to:
receive, from a sidelink transmitting user equipment (UE), one or more first transmissions over a first set of sidelink resources;
receive, from the sidelink transmitting UE, one or more second transmissions over a second set of sidelink resources; and
transmit, to the sidelink transmitting UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback.

2. The apparatus of claim 1, wherein the one or more processors are further configured to receive, from the sidelink transmitting UE, sidelink control information indicating at least a portion of the second set of sidelink resources, wherein the sidelink control information includes an indication of a request for feedback for multiple groups of sidelink resources, and wherein the one or more processors are configured to transmit the second feedback with the retransmission of at least the portion of the first feedback based at least in part on the indication.

3. The apparatus of claim 2, wherein the sidelink control information further includes a new feedback indicator for at least one of the multiple groups of sidelink resources, and wherein the one or more processors are configured to transmit the second feedback with the retransmission of at least the portion of the first feedback further based at least in part on the new feedback indicator.

4. The apparatus of claim 2, wherein the sidelink control information includes a group indicator indicating that the second feedback for the one or more second transmissions is associated with a second group, wherein the first feedback is indicated as associated with a first group.

5. The apparatus of claim 2, wherein the one or more processors further are configured to:
maintain a first codebook for the first group of the multiple groups of sidelink resources; and
maintain a second codebook or the second group of the multiple groups of sidelink resources,
wherein the one or more processors are configured to transmit the second feedback based on the second codebook and based at least in part on the group indicator indicating that the second feedback is associated with the second group.

6. The apparatus of claim 5, wherein the one or more processors are further configured to reset the second codebook based at least in part on transmitting the second feedback.

7. The apparatus of claim 1, wherein the one or more processors are further configured to receive, from the sidelink transmitting UE, sidelink control information indicating at least a portion of the second set of sidelink resources, wherein the sidelink control information includes an indication to trigger the retransmission in the second set of feedback resources, and wherein the one or more processors are configured to transmit the second feedback with the retransmission of at least the portion of the first feedback based at least in part on the indication.

8. The apparatus of claim 7, wherein the one or more processors are configured to transmit the second feedback with the retransmission at least in part by appending at least the portion of the first feedback to the second feedback based on a codebook associated with the second set of feedback resources.

9. The apparatus of claim 1, wherein the one or more processors are further configured to receive, from the sidelink transmitting UE, sidelink control information indicating at least a portion of the second set of sidelink resources, wherein the sidelink control information includes an indication of whether feedback is received, and wherein the one or more processors are configured to transmit the second feedback with the retransmission of at least the portion of the first feedback based at least in part on the indication not being set.

10. The apparatus of claim 9, wherein the one or more processors are configured to transmit the second feedback with the retransmission at least in part by appending at least the portion of the first feedback to the second feedback based on a codebook associated with the second set of feedback resources.

11. The apparatus of claim 9, wherein the one or more processors are further configured to receive, from the sidelink transmitting UE, sidelink control information indicating at least a portion of a third set of sidelink resources, wherein the sidelink control information includes a second indication that feedback is received, and wherein the one or more processors are further configured to flush the first feedback and the second feedback from a buffer based on the second indication.

12. The apparatus of claim 9, wherein the one or more processors are further configured to detect whether the indication is set based on comparing the indication to a last received indication in sidelink control information for the first set of sidelink resources.

13. The apparatus of claim 1, wherein the second set of sidelink resources includes a first subset for the retransmission of the first feedback and a second subset for the second feedback.

14. An apparatus for wireless communication, comprising:
a transceiver;
a memory configured to store instructions; and
one or more processors communicatively coupled with the transceiver and the memory, wherein the one or more processors are configured to:
transmit, to a sidelink receiving user equipment (UE), one or more first transmissions over a first set of sidelink resources;
transmit, to the sidelink receiving UE, one or more second transmissions over a second set of sidelink resources; and
receive, from the sidelink receiving UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback.

15. The apparatus of claim 14, wherein the one or more processors are further configured to transmit, to the sidelink receiving UE, sidelink control information indicating at least a portion of the second set of sidelink resources, wherein the sidelink control information includes an indication of a request for feedback for multiple groups of sidelink resources, and wherein the one or more processors are configured to receive the second feedback with the retransmission of at least the portion of the first feedback based at least in part on the indication.

16. The apparatus of claim 15, wherein the sidelink control information further includes a new feedback indicator for at least one of the multiple groups of sidelink resources, and wherein the one or more processors are configured to receive the second feedback with the retransmission of at least the portion of the first feedback further based at least in part on the new feedback indicator.

17. The apparatus of claim 16, wherein the one or more processors are further configured to transmit, to the sidelink receiving UE, second sidelink control information to request feedback for at least one or more third transmissions, wherein the second sidelink control information includes the new feedback indicator set based on whether the first feedback and second feedback are successfully received.

18. The apparatus of claim 15, wherein the sidelink control information includes a group indicator indicating that the second feedback for the one or more second transmissions is associated with a second group, wherein the first feedback is indicated as associated with a first group.

19. The apparatus of claim 18, wherein the one or more processors are further configured to transmit, to the sidelink receiving UE, second sidelink control information to request feedback for at least one or more third transmissions, wherein the second sidelink control information includes the group indicator set based on whether the first feedback and second feedback are successfully received.

20. The apparatus of claim 14, wherein the one or more processors are further configured to transmit, to the sidelink receiving UE, sidelink control information indicating at least a portion of the second set of sidelink resources, wherein the sidelink control information includes an indication to trigger the retransmission in the second set of feedback resources, and wherein the one or more processors are configured to receive the second feedback with the retransmission of at least the portion of the first feedback based at least in part on the indication.

21. The apparatus of claim 20, wherein the indication to trigger retransmission is set based on a timeline of the first set of feedback resources.

22. The apparatus of claim 20, wherein the one or more processors are configured to receive the second feedback with at least the portion of the first feedback appended to the second feedback based on a codebook associated with the second set of feedback resources.

23. The apparatus of claim 14, wherein the one or more processors are further configured to transmit, to the sidelink receiving UE, sidelink control information indicating at least a portion of the second set of sidelink resources, wherein the sidelink control information includes an indication of whether feedback is received, and wherein the one or more processors are configured to receive the second feedback with the retransmission of at least the portion of the first feedback based at least in part on the indication not being set.

24. The apparatus of claim 23, wherein the one or more processors are configured to receive the second feedback with at least the portion of the first feedback appended to the second feedback based on a codebook associated with the second set of feedback resources.

25. The apparatus of claim 14, wherein the second set of sidelink resources includes a first subset for the retransmission of the first feedback and a second subset for the second feedback.

26. A method for wireless communication at a sidelink receiving user equipment (UE), comprising:
receiving, from a sidelink transmitting UE, one or more first transmissions over a first set of sidelink resources;
receiving, from the sidelink transmitting UE, one or more second transmissions over a second set of sidelink resources; and
transmitting, to the sidelink transmitting UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback.

27. The method of claim 26, further comprising receiving, from the sidelink transmitting UE, sidelink control information indicating at least a portion of the second set of sidelink resources, wherein the sidelink control information includes an indication of a request for feedback for multiple groups of sidelink resources, and wherein transmitting the second feedback with the retransmission of at least the portion of the first feedback is based at least in part on the indication.

28. The method of claim 27, wherein the sidelink control information further includes a new feedback indicator for at least one of the multiple groups of sidelink resources, and wherein transmitting the second feedback with the retransmission of at least the portion of the first feedback is further based at least in part on the new feedback indicator.

29. A method for wireless communication at a sidelink transmitting user equipment (UE), comprising:
transmitting, to a sidelink receiving UE, one or more first transmissions over a first set of sidelink resources;
transmitting, to the sidelink receiving UE, one or more second transmissions over a second set of sidelink resources; and
receiving, from the sidelink receiving UE, second feedback for the one or more second transmissions in a second set of feedback resources, wherein the second feedback also includes, based on a failure associated with first feedback for the one or more first transmissions to be transmitted over a first set of feedback resources, a retransmission of at least a portion of the first feedback.

30. The method of claim 29, further comprising transmitting, to the sidelink receiving UE, sidelink control information indicating at least a portion of the second set of sidelink resources, wherein the sidelink control information includes an indication of a request for feedback for multiple groups of sidelink resources, and wherein receiving the second feedback with the retransmission of at least the portion of the first feedback is based at least in part on the indication.
